(19) United States
(12) Patent Application Publication
(10) Pub. No.: US 2010/0199964 A1
(43) Pub. Date: Aug. 12, 2010

(54) One-sided curved anchor slots in a cutting disc and process of producing same

(76) Inventor: Kevin Baron, Oxnard, CA (US)

Correspondence Address: SANDRA LEE LIPKIN A LAW CORPORATION, P.O.Box 3518, VENTURA, CA, 93006, US

(21) Appl. No.: 12/378,133

(22) Filed: Feb. 10, 2009

(51) Int. Cl. B28D 1/04; B26D 1/14

(52) U.S. Cl. 125/15; 83/676

(57) ABSTRACT

In a cutting disc which has a plurality of radial slots connecting with the peripheral edge of the disc wherein each radial slot curves to one side wherein the slot has a concave shape relative to the peripheral edge of the disc.

### BACKGROUND OF THE INVENTION

1. Field of the Invention

The field of this invention relates to a cutting disc which is constructed of metal, such as stainless steel, and has a peripheral edge which is formed into a plurality of supporting segments by a plurality of spaced apart radial notches formed within the body of the cutting disc. The outer surface of each supporting segment has bonded thereto a cutting segment in block form of an abrasive material which normally includes diamonds as the primary cutting substance due to their hardness. The cutting disc may be used dry or used with a fluid coolant for cooling the cutting disc. The coolant is to be supplied to the area of cutting with this coolant being for the purpose of cooling the cutting disc and carrying swarf, principally loose rock-like material and coolant, away from the area of the cut being made.

2. Description of the Prior Art

Diamond abrasive cutting discs have generally been classified into three distinct groups. The first group is the serrated or notched peripheral edge type of cutting disc which is old in the art and probably the earliest concept of the diamond cutting disc. This type of cutting disc is made by notching or slitting the peripheral edge of a steel disc and inserting into those notches or slits a paste of diamond grit and a holding material. The paste is then permitted to harden into a solid. This notched rim type of cutting disc has the merit of being virtually indestructible but cuts so poorly that it has no real acceptance for the cutting of exceedingly hard abrasive material such as cement, stone and asphalt. However, these notched rim types of cutting discs are made at the lowest price which makes them available for home hobby type of operations.

The second group of cutting discs consists of forming a continuous annulus of a compressed metallic powder containing diamond dust. This cutting disc is functionally superior to the notched rim type of cutting disc, but it too is unsatisfactory for the abrasive cutting operations common within industry because it has a disadvantage of being physically frail and liable to damage during usage due to the delicate nature of the bond between the annulus and the body of the disc. The use of this second cutting disc is confined in large part to precision operations such as the cutting of germanium, optical glass and other such precise uses.

The third, and most recent group of cutting discs, is the segmental type. This cutting disc is manufactured by forming a plurality of support segments (or lands) located between radial slots connecting with the peripheral edge of the cutting disc. On the outer surf ace of each support segment is mounted a cutting segment in the form of an abrasive block which commonly contains diamonds. These cutting segments are usually about two inches long and are brazed or welded to the peripheral edge of the steel body of the cutting disc. This type of segmented cutting disc has been accepted by the fields of usage that are most demanding on a cutting disc such as concrete sawing, masonry cutting and asphalt cutting. For such cutting applications, it is common to flush the cutting area continuously during the cutting operation with a fluid coolant in order to keep the blade as cool as possible and to flush from the cutting area loose rock-like material, spent abrasive and the like, all of which in combination with the coolant described are generally referred to as swarf.

Because cutting discs are utilized to cut hard and abrasive materials, it is common that the stresses created within the cutting discs result in cracks and actual loss of pieces of the cutting disc. One of the most common areas for breakage is at the inner end of one of the radial slots. To minimize the possibility of cracking at the inner end of a radial slot, it is common to form a hole, frequently referred to as a keyhole, at the end of each slot. It is the purpose of the hole to decrease the possibility of any cracking occurring within the body of the cutting disc. Besides keyholes, it is known to utilize numerous other configurations at the inner end of each radial slot which are believed to be superior in minimizing the possibility of cracking of the cutting disc.

Also, undercutting is a problem with each cutting disc. Undercutting is the forming of a groove within the body of the cutting disc at the radial inner end of the slots. If left unchecked, this groove will eventually result in failure of the cutting disc. It would be desirable to construct the cutting disc in such a manner so as to not concentrate the undercut at the inner end of the radial slots.

### SUMMARY OF THE INVENTION

The preferred embodiment of the present invention teaches a a cutting disc which is constructed of a thin metallic body having a diameter anywhere from a few inches to several feet. The cutting disc has a peripheral edge, and within that peripheral edge is formed a series of radial slots. Each radial slot curves to one side wherein the slot has a concave shape relative to the peripheral edge of the disc. The angle of curvature, the width of the slots and the length of the slots are variable. A common number of such radial slots would be about twenty, but it is to be understood that the number of slots will vary according to the diameter of the cutting disc with more slots being used in a larger diameter disc and less slots being used in a smaller diameter disc. Between each directly adjacent pair of radial slots is formed a support segment or land. On the outer edge of each support segment is bonded a cutting segment. The cutting segment comprises a block of abrasive material which generally includes diamonds. Each support segment is generally about an inch and a half to two inches in length.

The primary objective of the present invention is to construct a cutting disc that minimizes the possibility of cracking within the cutting disc even after extended usage of the cutting disc.

Another objective of the present invention is to construct a cutting disc which diminishes the effect of undercutting.

### BRIEF DESCRIPTION OF THE DRAWINGS

FIG. 1 is a front view of the cutting disc constructed in accordance with this invention.

FIG. 2 is a front view of an alternate embodiment of the cutting disc constructed in accordance with this invention.

FIG. 3 is an enlarged view of three of the radial notches of varying length and width incorporated within the cutting disc taken along line 3-3 in FIG. 1.

FIG. 4 is an enlarged view of three of the radial notches of varying length incorporated within the cutting disc in an alternate embodiment taken along line 4-4 in FIG. 2.

### DETAILED DESCRIPTION OF A PREFERRED EMBODIMENT

Turning to the drawings, the preferred embodiment is illustrated and described by reference characters that denote similar elements throughout the several views of the instant invention.

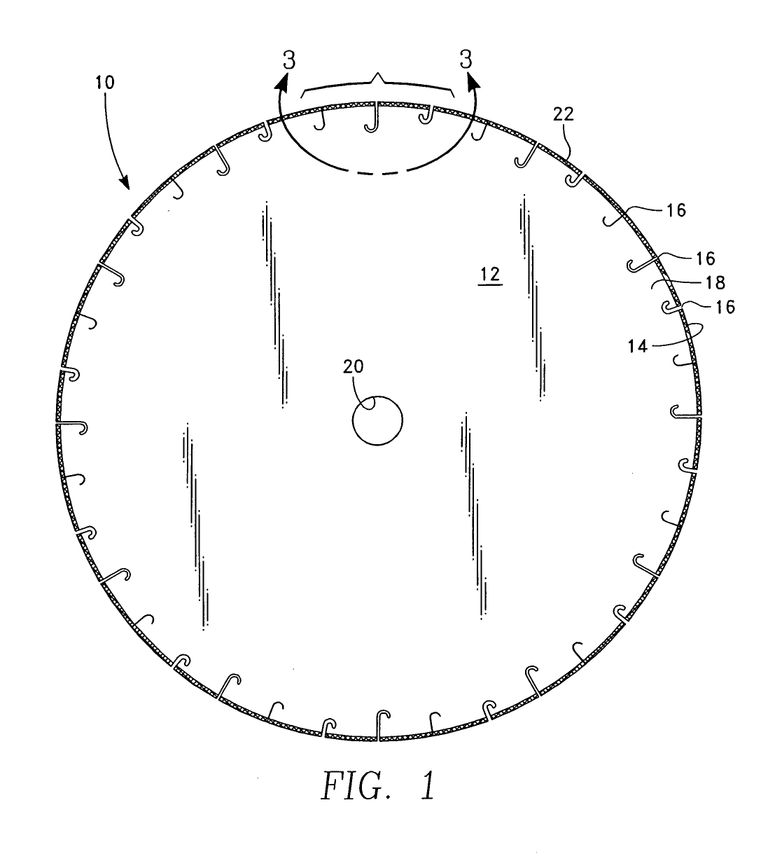

Referring particularly to the drawing, in FIG. 1, there is shown the preferred embodiment of the cutting disc 10 of this invention. The body 12 of the cutting disc 10 is to be formed of planar sheet metal, with steel generally being preferred. The body 12 has a peripheral edge 14. Included within the peripheral edge 14 is a plurality of radial slots 16. The radial slots 16 are of varying length and width. Each radial slot 16 curves to one side wherein the slot 16 has a concave shape relative to the peripheral edge of the disc 10. In this embodiment, it can be seen that the radial slots 16 have a generally “candy cane” shape and can curve to either direction, while maintaining the concave shape relative to the peripheral edge 14 of the disc 10. The portion of the body 12 that is located between a directly adjacent pair of radial slots 16 is defined as a support segment 18. Land is also used to define the support segment 18. A typical number for the radial slots 16 would be about twenty thereby forming twenty in number of the support segments 18.

It is to be noted that referring particularly to FIG. 1 it is desirable to vary the length of the radial slots 16. Some of the radial slots 16 are a half inch in length while others are five-eighths inch in length, three-quarters and still others are seven-eighths in length. Typical width of a radial slot would be one-eighth (0.125) of an inch. In using the cutting disc 10, there is a tendency to wear a groove within the body 12 directly at the inner end of each of the radial slots 16. If all the slots 16 were the same length, a single groove would be created which would result in premature failure of the cutting disc 10. To eliminate this possibility, by using radial slots 16 of various lengths, a plurality of grooves, rather than a single groove, is formed within the body 12. The forming of these grooves is referred to as undercutting. By forming a plurality of grooves rather than a single groove, a single deep cut groove is avoided and the structural integrity of the body 12 is maintained over an extended period of time thereby increasing the durability of the cutting disc 10. The body 12 includes a center hole 20 which is to be used for mounting and locking the cutting disc 10 onto a motorized, rotating, axially extending shaft (not shown).

The radial portion of the slot combined with the curved concave portion is formed as one continuous shape, thereby being created by a simple, improved process that results in a quicker cut in processing. The higher the radius of the curve of the slots, the greater the extension of the life of blade as heat reduction during use is achieved.

A cutting segment 22 is to be fixedly secured by brazing or welding onto the peripheral edge 14 with there being a separate cutting segment for each support segment 18. The length of the cutting segment 22 is to be identical to the length of the support segment 18. The cutting segment 22 is to comprise a block manufactured of a mass of diamond material impregnated within a bonding substance. The use of such cutting segments 22 is deemed to be conventional.

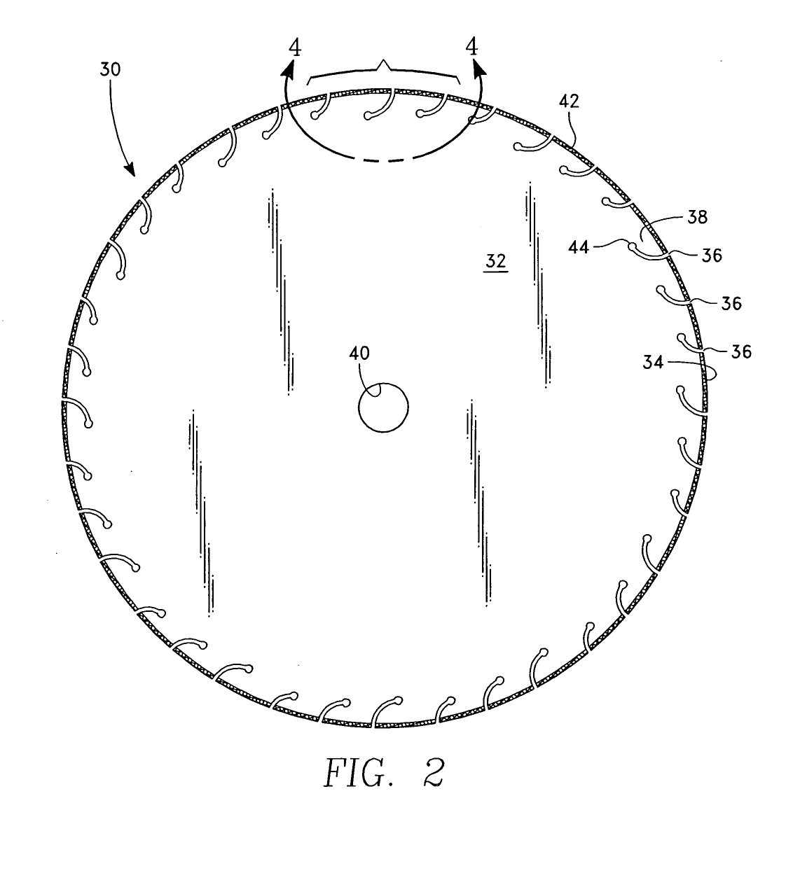

It is to be noted that each of the radial slots 16, though of varying length and widths, are all of the same configuration. In the case of the preferred embodiment, each slot 16 has a “candy cane” shape. FIG. 2 shows an alternate embodiment 30. Again the disc includes a main body 32 and a peripheral edge 34. Included within the peripheral edge 34 is a plurality of radial slots 36. These radial slots 36 are of varying length and width. Support segments 38 are found between each radial slot 36. Cutting segments 42 are formed on these support segments 38 just as they are in the preferred embodiment. A hole 40 is found in the center of the disc 30. The radial slots 36 of the alternate embodiment have an arcuate shape, each curving in the same direction, and terminate in a rounded hole 44. These holes minimize the creation of cracks in the body 32. The diameter of the hole 44 will generally be in the range of about one-quarter inch.

One of the functions of the radial slots 16 is to allow for expansion and contraction due to the creation of heat during usage of cutting disc 10. Also, the slots 16 function to allow for the swarf to escape from the cutting area. Additionally, the radial slots 16 function to allow the slurry to penetrate around each of the cutting segments 22 which functions to better cool the cutting segments 22. Failure of cutting discs 10 due to cracking results in their limited life, escalating operational costs by millions of dollars annually for users within the United States.

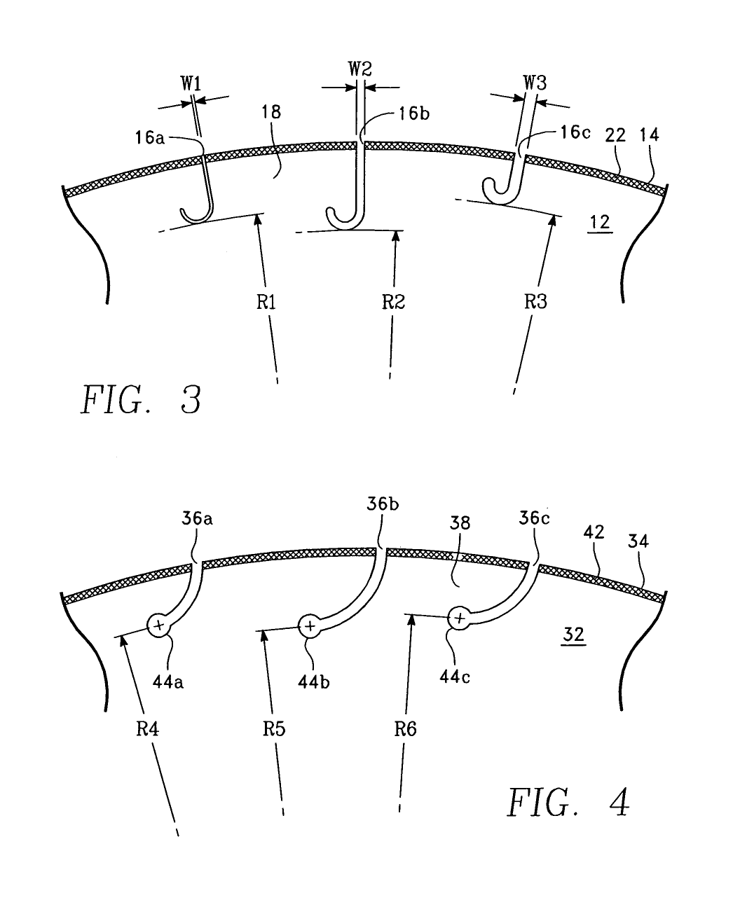

FIGS. 3 and 4 show close ups each of three of the radial slots of each embodiment. As can be seen, the widths W1, W2, W3 are variable and staggered. Furthermore, the lengths of the slots result in different radii R1, R2, R3, R4, R5, R6 from the center.

The discussion included in this patent is intended to serve as a basic description. The reader should be aware that the specific discussion may not explicitly describe all embodiments possible and alternatives that are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A cutting disc for cutting asphalt, concrete and stone, said cutting disc comprising:
a circular shaped body having a peripheral edge;
a plurality of radial slots formed within said body, said radial slots being spaced apart, said body defining a support segment between each directly adjacent pair of said radial slots, each said radial slot having an open outer end connecting with said peripheral edge, each said radial slot having an inner end that curves to one side wherein said radial slots have a concave shape relative to said peripheral edge of said disc; and
a cutting segment fixedly mounted on each said support segment at said peripheral edge, there being a separate said cutting segment for each said support segment, each said cutting segment comprising an abrasive block.

2. The cutting disc as defined in claim 1 wherein said radial slots have variable lengths relative to adjacent radial slots.

3. The cutting disc as defined in claim 1 wherein said radial slots have variable widths relative to adjacent radial slots.

4. The cutting disc as defined in claim 1 wherein said radial slots terminate in a hole.
